(19) United States
(12) Patent Application Publication
(10) Pub. No.: US 2017/0147397 A1
(43) Pub. Date: May 25, 2017

(54) ENVIRONMENT PREFERENCE

(71) Applicant: HEWLETT PACKARD ENTERPRISE DEVELOPMENT LP, Houston, TX (US)

(72) Inventors: Jeffrey William Kramer, Austin, TX (US); Rajeev Pandey, Corvallis, OR (US); Matthew Allen Farna, Highland, MI (US); Patrick O Cox, Houston, TX (US); Rosendo F Jimenez, Rio Rancho, NM (US); Brian Thomas Tully, Hyde Park, NY (US); Samuel Francis Choi, Sunnyvale, CA (US)

(21) Appl. No.: 15/300,303

(22) PCT Filed: Apr. 11, 2014
(86) PCT No.: PCT/US2014/033846

§ 371 Date: Sep. 29, 2016

(51) Int. Cl. G06F 9/48

(52) U.S. Cl. CPC G06F 9/4831; G06F 9/4881

(57) ABSTRACT

In one implementation, a job dispatch engine can comprise a job engine to retrieve a job from a job store, a preference engine to receive a set of preference information, a validation engine to identify availability of an execution environment associated with the set of preference information, and a dispatch engine to dispatch the job to the execution environment based on the availability. In another implementation, a method for dispatching a job can comprise receiving a job from a job store, interrogating a source for an environment preference, identifying an execution environment based on the environment preference and a policy rule, and validating the execution environment for availability to execute the job.

### BACKGROUND

A network application can reside in an environment to execute a job. A job can be automated for execution via a network application deployment. For example, infrastructure automation systems commonly execute scripts and program code on behalf of a user. A job can be executed based on an event or a schedule.

### BRIEF DESCRIPTION OF THE DRAWINGS

FIG. 1-3 are block diagrams depicting example job automation systems.

FIG. 4 depicts example environments in which various example job automation systems can be implemented.

FIG. 5 depicts example modules used to implement example job automation systems.

FIG. 6-8 are flow diagrams depicting example methods for automating job execution.

### DETAILED DESCRIPTION

In the following description and figures, some example implementations of job dispatch systems and/or methods for dispatching a job. Programs to be executed as job may include configuration options and the workloads for executing the jobs can vary in complexity, duration, security, and size. Though it is desirable to use the same automation system, a single execution environment is not always appropriate for the environmental specification of each job of a job queue.

Various examples described below relate to automating job execution based on an interrogation for a preference. Utilizing preference information from an interrogation allows for multiple execution services to be adapted to a single job platform that provides a central queuing system that distributes jobs to execution environments based on preference information and provides for the ability to distribute dispatching and execution of the jobs over a distributed computing environment.

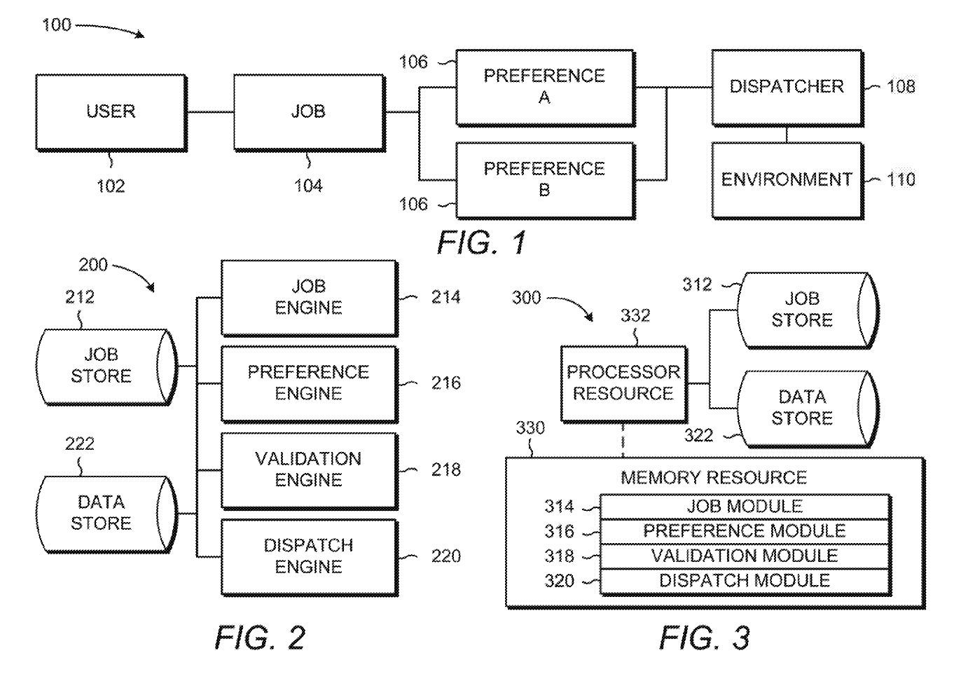

FIGS. 1-3 are block diagrams depicting example job automation systems. Referring to FIG. 1, a user 102 can execute a job 104 to perform an automated task using a dispatcher 108 to send the job 104 to an environment 110 for execution. As used herein, an environment 110 for execution of a job 104 can be any appropriate combination of circuitry and executable instructions capable of executing a job 104, such as a single compute device, a cluster of compute devices, or a cloud. An environment 110 and/or resources of an environment 110 can change during any appropriate time, which can affect how a job 104 is executed in the environment 110. A job 104, as used herein, represents a set of instructions to perform a task, such as an automated task of an application or a scheduled task set by a user 102.

The job dispatch system 100 can utilize a set of preferences 106 to assist the dispatcher 108 in selecting an environment 110. For example, preference A 106 can be associated with a high-throughput environment preference associated with the attributes of the job 104 and the preference B 106 can be a low cast environment 110 preferred by the user 102. The job dispatch system 100 can perform an interrogation to obtain a preference 106. An interrogation can include verification of an existence of an environment preference 106, retrieval of the environment preference 106 when the existence of the environment preference 106 is verified, and validation that the execution environment 110 associated with the preference 106 is available to execute the job 104. The job dispatch system 100 can use the preferences 106 found during an interrogation session to determine an order of preference of execution environments 110. To use the previous example, the dispatcher 108 can determine if the high-throughput environment 110 is available to execute the job 104, and if it is not, then the dispatcher 108 can dispatch to the low cost environment 110 if it is available. The job dispatch system 100 can interrogate any number of sources to find an environment preference 106, such as a job 104, a user 102, and an environment default.

Referring to FIG. 2, an example job dispatch system 200 generally comprises a job engine 214, a preference engine 216, a validation engine 218, and a dispatch engine 220. In general, the system 200 can use the engines 214, 216, 218, and 220 to retrieve a job and an environment preference to dispatch the job to an execution environment that is available to execute the job based on the preference. For example, the system 200 can interrogate a plurality of sources until a preference is found by identifying the existence of preference information from a source, retrieving the preference information when it exists, and checking the availability of an execution environment associated with the preference information. The system 200 can include a job store 212 to store a job for execution and a data store 222 to store the data used and/or produced by the engines of the system 200. The terms “include,” “have,” and variation thereof, as used herein, mean the same as the term “comprise” or appropriate variation thereof. Furthermore, the term “based on,” as used herein, means “based at least in part on.” Thus, a feature that is described as based on some stimulus can be based only on the stimulus or a combination of stimuli including the stimulus.

The job engine 214 represents any combination of circuitry and executable instructions to receive a job. For example, the job engine 214 can retrieve a job from a job store 212 to contain jobs for execution. The job store 212 can be and/or include a data structure to contain a plurality of jobs, such as a queue.

The preference engine 216 represents any combination of circuitry and executable instructions to search a source for preference information. Preference information can include a type, an attribute, a rule, a policy, a priority, or other form of classification to identify an execution environment. For example, the preference can be based on a type of job or a group attribute of job to ensure the jobs associated with the group attribute or type are sent to an environment meeting a specification of the group attribute or type, such as a secure execution environment. A preference can include specific or general preferences. For example, the preference information can be for a particular cluster of hosts to execute a job or generic priority such as lowest cost. A preference can include a selection method such as least loaded, lowest cost, nearest neighbor, highest security, tightest packed, and the like. A source can include the job retrieved by the job engine 214, a user associated with the job, and a data store to contain preferences, such as a default execution environment preference.

The preference engine 216 can perform steps of interrogation. For example, the preference engine 216 can identify a source, inspect the source for preference information, and retrieve the preference information when the source contains a preference. As mentioned above, sources include the job itself and the user. The preference engine 216 can inspect a plurality of sources based on priority. For example, the preference engine 216 can search the job meta data for a preference first (and if there is a job preference, send the job preference to the validation engine 218 and dispatch to the execution environment associated with the job preference when it is valid) and search a user profile of a user for a preference second when no job preference is found. The preference engine 216 can interrogate a source, such as a data store 222, for default environment information. For example, the preference engine 216 can inspect meta data of the job for a job environment preference to add to a set of preference information, inspect a profile of a user for a user environment preference to add to the set of preference information when the meta data of the job lacks the job environment preference, and retrieve a default environment preference to add to the set of preference information when the profile of the user lacks the user environment associated with the set of preference information.

Preference information can include job preference information, user preference information, and/or default environment preference information. A job preference can include an amount of memory, an amount of writeable disk space, a drive type, an estimated running time, a language or platform to execute the job, and the like. A user preference can include a cost preference (such as cheapest possible execution, certain amount of jobs per hour), security, and geographical distribution. A default environment preference can include a generic environment or method classification such as least loaded, lowest cost, nearest neighbor, highest security, tightest packed, and the like. Preference information can invoke optimization techniques to dispatch jobs efficiently based on the preferences.

The data store 222 can contain the set of preference information and/or a preference from a source. For example, the data store 222 can contain the meta data of the job, a user profile of a user, the default execution environment, and a service level agreement (“SLA”) term. The preference engine 216 can perform a retrieval of the set of preference information from a data store. The data store can contain the set of preference information prior to job retrieval and/or be updated during interrogation to provide dynamic environment allocation during automated job execution.

The preference engine 216 can retrieve a user preference from a user profile or directly from the user via a user interface. For example, the preference engine 216 can retrieve a user preference from a user profile. For another example, the preference engine 216 can cause a request for the user environment preference to present to a user for adding the user environment preference to the profile of the user.

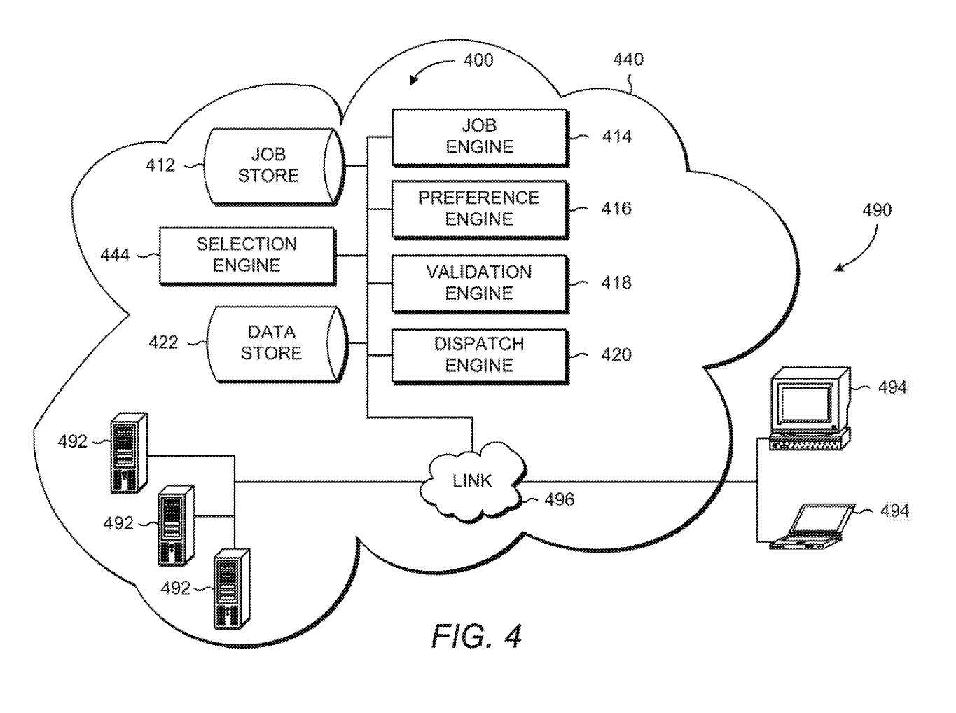

The preference engine 216 can retrieve multiple preferences to consider in selecting an execution environment for a job. For example, the preference engine 216 can retrieve a job environment preference and the user environment preference to add the job environment preference and the user environment preference to the set of preference information where the selection of an execution environment is based on the set of preference information. For another example, the job interrogation can provide an amount of writeable disk space specified for the job and the user interrogation can provide a cost preference and an execution environment can be identified to meet both the amount of writeable disk space and the cost preference. This is discussed further in the description associated with the selection engine 444 of FIG. 4.

The preference engine 216 can work in conjunction with the validation engine 218 to identify an execution environment to execute a job. The validation engine 218 represents any combination of circuitry and executable instructions to identify availability of an execution environment associated with the set of preference information. For example, the validation engine 218 can validate an execution environment associated with a job preference is available to execute the job. Validation can assist the job in execution rather than waiting for an execution environment that may be delayed due to errors, inactivity, or high volume. Thus, a set of preference information can improve efficiency of completion of the job queue. For example, the job preference can request an environment with a particular private cluster that is unavailable based on a query by the validation engine 218 and the job can be executed based on a user preference or the default execution environment instead of the job preference due to the lack of availability.

The dispatch engine 220 represents any combination of circuitry and executable instructions to dispatch the job to the execution environment. For example, the dispatch engine 220 can, in conjunction with the preference engine 216 and the validation engine 218, identify an execution environment based on the environment preference and the availability of the execution environment. When an available environment is identified to execute the job (based on the set of preference information), the dispatch engine 220 can send the job to the available environment for execution.

FIG. 3 depicts the example job dispatch system 300 can be implemented on a memory resource 330 operatively coupled to a processor resource 332. The processor resource 332 can be operatively coupled to a job store 312 and a data store 322. The job store 312 and the data store 322 can be the same as the job store 212 and the data store 222 of FIG. 2, respectively.

Referring to FIG. 3, the memory resource 336 can contain a set of instructions that are executable by the processor resource 332. The set of instructions can implement the system 300 when executed by the processor resource 332. The set of instructions stored on the memory resource 330 can be represented as a job module 314, a preference module 316, a validation module 318, and a dispatch module 320. The processor resource 332 can carry out a set of instructions to execute the modules 314, 316, 318, and 320, and/or any other appropriate operations among and/or associated with the modules of the system 300. For example, the processor resource 332 can carry out a set of instructions to receive a job from a job store; cause an interrogation of the job, a user, and an environment default until an environment preference is found; identify an execution environment based on the environment preference based on availability; and dispatch the job to the execution environment. The job module 314, the preference module 316, the validation module 318, and the dispatch module 320 represent program instructions that when executed function as the job engine 214, the preference engine 216, the validation engine 218, and the dispatch engine 220 of FIG. 2, respectively.

The processor resource 332 can be one or multiple central processing units (“CPUs”) capable of retrieving instructions from the memory resource 330 and executing those instructions. Such multiple CPUs can be integrated in a single device or distributed across devices. The processor resource 332 can process the instructions serially, concurrently, or in partial concurrence.

The memory resource 330, the job store 312, and the data store 322 represent a medium to store data utilized and/or produced by the system 300. The medium can be any non-transitory medium or combination of non-transitory mediums able to electronically store data, such as modules of the system 300 and/or data used by the system 300. For example, the medium can be a storage medium, which is distinct from a transitory transmission medium, such as a signal. The medium can be machine readable, such as computer readable. The memory resource 330 can be said to store program instructions that when executed by the processor resource 332 implements the system 300 of FIG. 3. The memory resource 330 can be integrated in the same device as the processor resource 332 or it can be separate but accessible to that device and the processor resource 332. The memory resource 330 can be distributed across devices. The memory resource 330, the job store 312, and the data store 322 can represent the same physical medium or separate physical mediums. The data of the data store 322 can include representations of data and/or information mentioned herein, such as a job, meta data of a job, a user preference, and an environment.

In the discussion herein, the engines 214, 216, 218, and 220 of FIG. 2 and the modules 314, 316, 318, and 320 of FIG. 3 have been described as a combination of circuitry and executable instructions. Such components can be implemented in a number of fashions. Looking at FIG. 2, the executable instructions can be processor executable instructions, such as program instructions, stored on the memory resource 330, which is a tangible, non-transitory computer readable storage medium, and the circuitry can be electronic circuitry, such as processor resource 332, for executing those instructions.

In one example, the executable instructions can be part of an installation package that when installed can be executed by the processor resource 332 to implement the system 300. In that example, the memory resource 330 can be a portable medium such as a compact disc, a digital video disc, a flash drive, or memory maintained by a computer device, such as a service device 492 of FIG. 4, from which the installation package can be downloaded and installed. In another example, the executable instructions can be part of an application or applications already installed. The memory resource 330 can include integrated memory such as a hard drive, a solid state drive, random access memory (“RAM”), read only memory (“ROM”), electrically erasable programmable ROM (“EEPROM”), flash memory, or the like.

FIG. 4 depicts example environments in which various example job automation systems can be implemented. The example environment 490 is shown to include an example system 400 for dispatching a job. The system 400 (described herein with respect to FIGS. 1-3) can represent generally any combination of circuitry and executable instructions to dispatch a job. The system 400 can include a job store 412, a data store 422, a job engine 414, a preference engine 416, a validation engine 418, and a dispatch engine 420 that are the same as the job store 212, the data store 222, the job engine 214, the preference engine 216, the validation engine 218, and the dispatch engine 220 of FIG. 2, respectively, and the associated descriptions are not repeated for brevity.

The system 400 can include a selection engine 444. The selection engine 444 represents any combination of circuitry and executable instructions to identify the execution environment based on flexibility of the set of preference information. As mentioned herein, the system 400 can receive multiple preferences and/or preferences from multiple sources. The selection engine 444 can optimize job execution by selecting an execution environment that aligns with the set of preference information received by the preference engine 416. The set of preference information can include an identifier of flexibility with each preference or a policy rule that has a flexibility associated with a preference. For example, a preference A can have a rigid identifier to indicate the execution environment should align with preference A, and a preference B can have a soft identifier to indicate the execution environment can align with preference B when possible. In that example, the identifiers can be optimized to provide an execution environment when the set of preference information does not align directly with any available execution environments. The selection engine 444 can receive policy rule to assist in determination of the execution environment where the policy rule can classify a preference and associated flexibility with the preference. For example, the selection engine 444 can receive a first policy rule from a user that has a soft rule to optimize cost of the job execution and a hard rule from the job that requires the environment to execute the job using a specific execution platform. The flexibility identifiers and/or rules can provide for a wide array of possible execution environments depending on the preferences associated with the sources known to the preference engine 416.

The example environment 490 can include compute devices, such as user devices 494 and service devices 492. For example, a user device 494 can provide access to a web interface for a user to manage job automation in an environment (or a plurality of environments) provided by the service devices 492. The compute devices can be located on separate networks 440 or part of the seine network 440. The example environment 490 can include any appropriate number of networks 440. The example system 400 can be integrated into a compute device or distributed across a combination of compute devices and/or networks 440. The environment 490 can include a cloud compute environment. For example, networks 440 can be distributed networks comprising virtual computing resources or “clouds.” Any appropriate combination of the system 400 and compute devices can be a virtual instance of a virtual shared pool of resources. The engines and/or modules of the system 400 herein can reside and/or execute “on the cloud” (e.g. reside and/or execute on a virtual shared pool of resources).

The service devices 492 represent generally any compute devices configured to respond to a network request received from a user device 494, whether virtual or real. For example, networks 440 can be cloud computing environments executing an infrastructure as a service (“IaaS”) model of infrastructure available as service devices 492. For another example, the service device 492 can be a virtual machine of the network 440 providing a job execution environment and the user device 494 can be a compute device configured to manage the job execution automation and communicate with the environment service. The user devices 494 represent generally any compute device configured with a browser or other application to communicate a network request and receive and/or process the corresponding responses. The system 400 can provide an application programming interface (“API”) for the service devices 492 and the user devices 494 to interact with the system 400. For example, the system 400 can provide a preference option associated with the environment preference via an API to allow the user to enter a preference into the system 400. For another example, the service devices 492 can use an API to provide preference information (such as a group attribute of a job that can be executed on the provided environment) and availability information regarding environments.

A link 496 represents generally one or any combination of a cable, wireless connection, fiber optic connection, or remote connections via a telecommunications link, an infrared link, a radio frequency link, or any other connectors of systems that provide electronic communication. The link 496 can include, at least in part, intranet, the Internet, or a combination of both. The link 496 can also include intermediate proxies, routers, switches, load balancers, and the like.

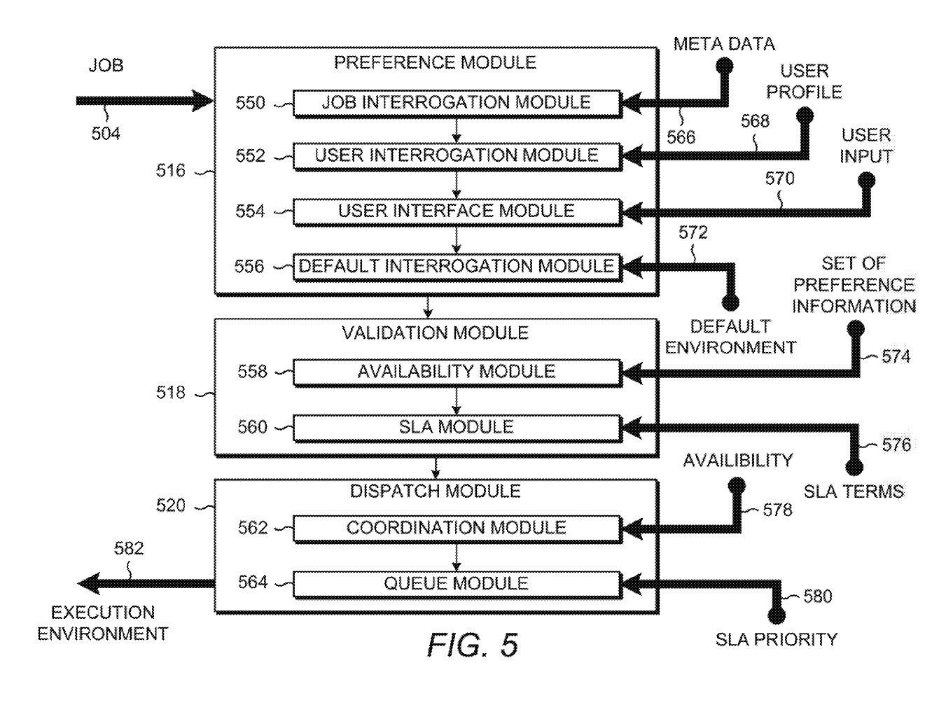

Referring to FIGS. 2-4, the engines 214, 216, 218, and 220 of FIG. 2, and/or the modules 314, 316, 318, and 320 of FIG. 3 can be distributed across devices 492, 494, or a combination thereof. The engine and/or modules can complete or assist completion of operations performed in describing another engine and/or module. For example, the dispatch engine 420 of FIG. 4 can request, complete, or perform the methods or operations described with the dispatch engine 220 of FIG. 2 as well as the preference engine 216 of FIG. 2, the validation engine 218 of FIG. 2, and the selection engine 444 of FIG. 4. The engines of the system 400 can perform the example methods described in connection with FIGS. 5-7.

FIG. 5 depicts example modules used to implement example job automation systems. Referring to FIG. 5, the example modules of FIG. 5 generally include a preference module 516, a validation module 518, and a dispatch module 520 that can be the same as the preference module 316, the validation module 318, and the dispatch module 320 of FIG. 3.

The system can perform an interrogation of for preferences of an execution environment when a job 504 is received. The preference module 516 can gather preference information from available sources. For example, the preference module 516 can interrogate sources in a cascading style until a preference is found. The preference module 516, as shown in FIG. 5, can include a job interrogation module 550, a user interrogation module 552, a user interface module 554, and a default interrogation module 556. The job interrogation module 550 represents program instructions that when executed function as a combination of circuitry and executable instructions to retrieve meta data 566 associated with the job 504 from a data store and search the meta data 566 for a preference. The user interrogation module 552 represents program instructions that when executed function as a combination of circuitry and executable instructions to retrieve a user profile 568 associated with a user from a data store and search the user profile 568 for a preference. If a user preference is not found in the user profile 568, the system can cause a request for a preference to present to the user via the user interface module 554. The user interface module 554 represents program instructions that when executed function as a combination of circuitry and executable instructions to cause a request for a preference to present to a user via a user interface and receive user input 570 for the user preference. The default interrogation module 556 represents program instructions that when executed function as a combination of circuitry and executable instructions to retrieve a preference for a default environment 572 from a data store. Using modules 550, 552, 554, and 556, the preference module 516 can collect a set of preference information 574 and make the set of preference information 574 available to determine an execution environment 582 to execute the job 504.

The validation module 518, as depicted in FIG. 5, can include an association module 558 and an SLA module 560. The availability module 558 represents program instructions that when executed function as a combination of circuitry and executable instructions to ascertain the availability status 578 of an execution environment 582 associated with the set of preference information 574. The association module 558 can associate the set of preference information 574 to identify an execution environment 582 and request the status from the execution environment 582. The availability 578 can be used to determine which execution environment 582 to execute the job 504. The validation module 518 can include an SLA module 560 that represents program instructions that when executed function as a combination of circuitry and executable instructions to verify an execution environment can meet a set of terms 576 of an SLA. For example, the execution environment 582 identified by the user preference may be available, but sending the job 504 to the execution of the job 504 on that environment 582 may fail the SLA terms 576 and another execution environment 582 should be selected for dispatching the job 504.

The dispatch module 520, as depicted in FIG. 5, can include a coordination module 562 and a queue module 564. The coordination module 562 represents program instructions that when executed function as a combination of circuitry and executable instructions to coordinate the information from the preference module 516, the validation module 518, and a selection module, such as selection module 444 of FIG. 4, of the system in the determination of which execution environment 582 should receive the job 504 based on the set of preference information 574. For example, the coordination module 562 can utilize availability status information 578 to identify an execution environment 582 that meets the set of preference information 574 and the availability information 578. If an execution environment 582 is available that meets the set of preference information 574, then the dispatch module 520 can dispatch the job 504 to the execution environment 582. If no execution environment 582 is identified to meet the set of preference information 574 and the availability 578, the job 504 can be sent to the queue based on an SLA priority 580 via the queue module 564. The queue module 564 represents program instructions that when executed function as a combination of circuitry and executable instructions to send a job 504 to the queue of the job store. The SLA priority 580 can be used to determine which of any of the available execution environments 582 can execute the job 504 optimized to meet the SLA terms when the preferred execution environments 582 are not available.

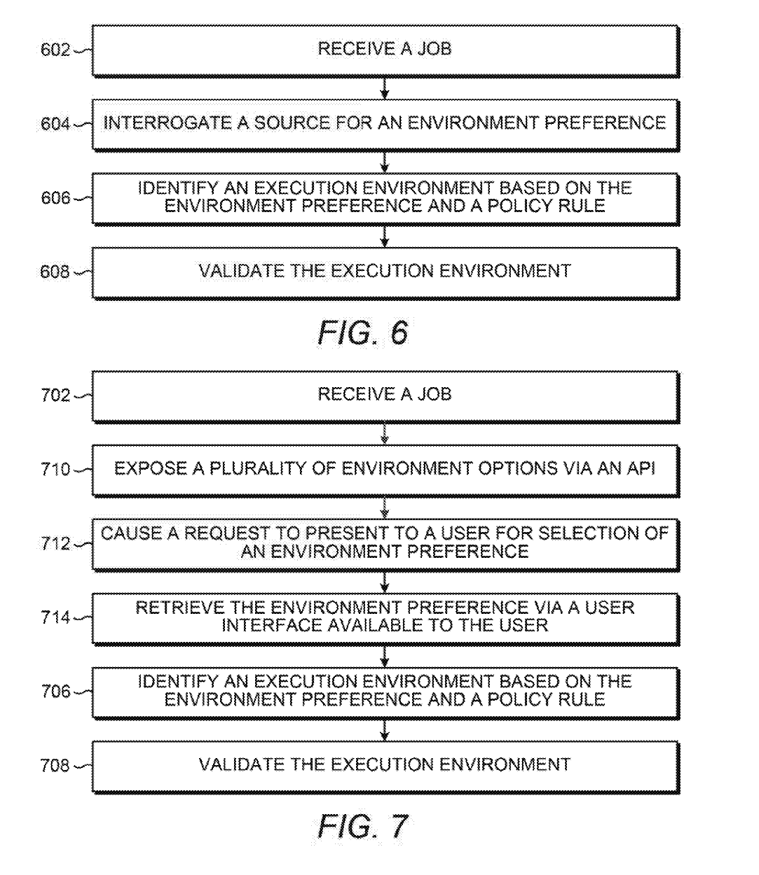

FIGS. 6-8 are flow diagrams depicting example methods for automating job execution. Referring to FIG. 6, example methods for dispatching a job can generally comprise receiving a job, interrogating a source for an environment preference, identifying an execution environment based on the environment preference and a policy rule, and validating the execution environment.

At block 602, a job is received. A job can be retrieved from a job store, such as a job queue. At block 604, a source is interrogated for an environment preference. The source can be one of the meta data of the job received at block 602, a user profile, and a default environment profile, and the environment preference can be one of a job preference associated with the job, a user preference associated with the user of the job, and a default environment preference associated with a default environment.

At block 606, an execution environment is identified based on the environment preference retrieved at block 604 and a policy rule. The policy rule can provide assistance in identifying an appropriate execution environment based on flexibility of the rule and/or preference. For example, the policy rule can be one of a hard rule to select the execution environment associated with the environment preference when the environment preference has a rigid level of flexibility and a soft rule to select the execution environment associated with the environment preference when the environment preference has a yielding level of flexibility. In that example, the rigid level of flexibility permits only environments that qualify for the preference to execute the job and the yielding level of flexibility places environment selection priority on qualifying environments over non-qualifying environments with regards to the preference. The policy rule can help determine whether an execution environment is appropriate when it may not completely satisfy the set of preference information retrieved at block 604.

At block 608, the execution environment is, validated for availability to execute the job. The availability status of the execution environment identified at block 606 can be identified and used to determine whether the job can be sent to the identified execution environment, whether more preference information can be retrieved to select another environment, or whether the job should be requeued for lack of availability of execution environments that satisfy the set of preference information. For example, the job can be returned to the job queue based on a priority of a SLA term when the execution environment identified at block 606 is not available to execute the job.

FIG. 7 includes blocks similar to blocks of FIG. 6 and provides additional blocks and details. In particular, FIG. 7 depicts additional blocks and details generally regarding exposing a plurality of environment options via API, causing a request to present to a user for selection of an environment preference, and retrieving the environment preference via a user interface available to the user. Blocks 702, 706, and 708 are the same as blocks 602, 606, and 608 of FIG. 6 and, for brevity, their respective descriptions have not been repeated.

At block 710, a plurality of environment options are exposed via an API. For example, the user interface can display the plurality of environment options for the user to identify a user preference where the plurality of environment options is retrieved from the job dispatch system via a first API call and the user preference is returned to the job dispatch system through a second API call. For another example, a system separate from the job dispatch system, such as a user interface system, can consume or otherwise interact with the job dispatch system via an API.

At block 712, a request is caused to present to a user for selection of an environment preference. For example, a preference engine, such as preference engine 216 of FIG. 2, can request a user preference directly from a user via a user interface to display the request. At block 714, the environment preference is retrieved via a user interface available to the user. The request can return user input to the preference engine to use as a user environment preference in identification of an execution environment for a job. The preference engine can directly or indirectly cause the request to present the user and receive the user input.

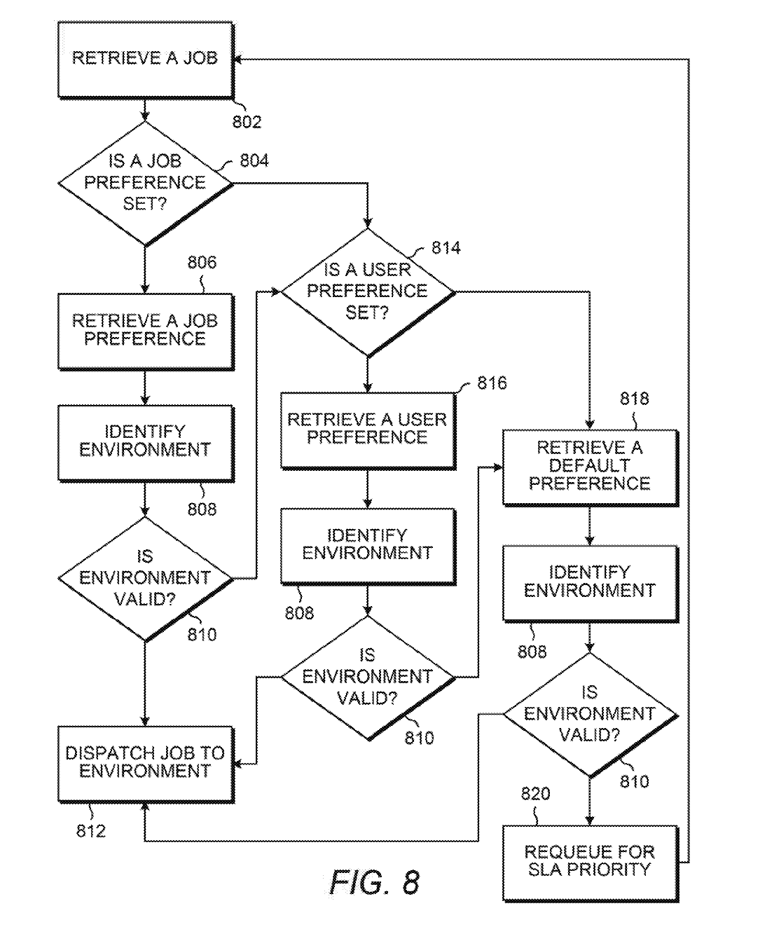

FIG. 8 depicts example methods for dispatching a job. In particular, the example methods depicted in FIG. 8 show a cascade technique to obtain preference information and dispatch the job based on the preference information. A cascade technique can be appropriate for efficient environment selection because the preference associated with the job is job-specific and likely to be the most important preference to fulfill if a job preference exists. In a similar fashion, other preferences and policies can be provided by the user as a secondary recourse, and as a final recourse the default environment can be searched for based on a generic policy, such as least utilized.

Referring to FIG. 8, a job can be retrieved from a job queue at block 802. The method can identify whether an execution environment preference has been set on the job itself at block 804. If a job preference is identified, the job preference can be retrieved at block 806. An environment associated with the job preference can be identified at block 808 and validated at block 810 (e.g. check for availability of the environment and/or compliance with SLA terms). If the execution environment identified by the job preference is valid, the dispatcher can dispatch the job to the identified environment at block 812. If the environment of the job preference is not valid, the method can search for a user preference at block 814.

If a job preference is not set at block 804 or if the environment identified by the job preference is not valid, the method can identify whether an execution environment preference has been set by the user at block 814. If a user preference is identified, the user preference can be retrieved at block 816. For example, the user preference can be retrieved from a user profile in a data store or retrieved as user input from a request directly to the user via a user interface With the user preference received, an execution environment can be identified at block 808 and validated at block 810 based on the user preference, and the job can be dispatched to the environment of the user preference at block 812 when the environment is valid. If the environment of the user preference is not valid, the method can search for a default execution environment at block 818.

If a user preference is not set at block 814 or if the environment identified by the user preference is not valid at block 810, the method can retrieve a default preference for a default execution environment at block 818. The default environment is identified (e.g. using a least loaded method) at block 808 and validated at block 810. If the environment identified using the default preference is valid, the job can be sent to the dispatcher to be executed at the identified environment. If the default environment is not valid, the job can be returned to the job queue for execution based on SLA priority. For example, the job can be returned to the queue at block 820 to meet SLA priority in the event that no execution environment is available to meet any of the above preferences. When the job returns to the dispatch for environment selection, the execution environment can be identified to execute the job based on the t e SLA. For example, the preferences received can indicate that a high speed environment should be used and when no high speed environments are available, the job can be requeued to dispatch to an environment having a speed below the high speed environment, but is still able to fulfill the SLA terms.

Although the flow diagrams of FIGS. 5-8 illustrate specific orders of execution, the order of execution may differ from that which is illustrated. For example, the order of execution of the blocks may be scrambled relative to the order shown. Also, the blocks shown in succession may be executed concurrently or with partial concurrence. All such variations are within the scope of the present invention.

The present description has been shown and described with reference to the foregoing examples. It is understood, however, that other forms, details, and examples may be made without departing from the spirit and scope of the invention that is defined in the following claims.

What is claimed is:

1. A job dispatch system comprising:
a job engine to retrieve a job from a job store;
a preference engine to:
inspect meta data of the job for a job environment preference to add to a set of preference information;
inspect a profile of a user for a user environment preference to add to the set preference information when the meta data of the job lacks the job environment preference;
retrieve a default environment preference to add to the set of preference information when the profile of the user lacks the user environment preference; and
a validation engine to identify availability of an execution environment associated with the set of preference information; and
a dispatch engine to dispatch the job to the execution environment based on the availability.

2. The system of claim 1, wherein the preference engine cause one of:
a request for the user environment preference to present to the user for adding the user environment preference to the profile of the user; and
a retrieval of the set of preference information from a data store, the data store to contain the set of preference information prior to job retrieval.

3. The system of claim 2, wherein the data store comprises the meta data of the job, the profile of the user, and the default execution environment.

4. The system of claim 1, wherein the preference engine is to retrieve the job environment preference and the user environment preference to add to the set of preference information.

5. The system of claim 4, comprising:
a selection engine to identify the execution environment based on flexibility of the set of preference information.

6. A computer readable media comprising a set of instructions executable by a processor resource to:
receive a job from a job store;
cause an interrogation of the job, a user, and an environment default until an environment preference is found, the interrogation to include:
verification of an existence of the environment preference; and
retrieval of the environment preference when the existence is verified;
identify an execution environment based on the environment preference; and
dispatch the job to the execution environment.

7. The medium of claim 6, wherein the set of instructions is executable by the processor resource to:
validate the execution environment is available to execute the job.

8. The medium of claim 6, wherein the set of instructions is executable by the processor resource to:
cause a request to present to a user for the environment preference, the environment preference associated with an attribute of the job.

9. The medium of claim 6, wherein the set of instructions is executable by the processor resource to:
provide a preference option associated with the environment preference via an application programming interface.

10. The medium of claim 9, wherein the environment preference is based on a group attribute of the job.

11. A method for dispatching a job comprising:
receiving a job from a job store;
interrogating a source for an environment preference, the environment preference to be one of a job preference associated with the job, a user preference associated with the user of the job, and a default preference associated with a default environment;
identifying an execution environment based on the environment preference and a policy rule; and
validating the execution environment for availability to execute the job.

12. The method of claim 11, comprising:
returning the job to a queue based on a priority of a service level agreement term when the execution environment is not available to execute the job.

13. The method of claim 11, wherein the policy rule is one of:
a hard rule to select the execution environment associated with the environment preference when the environment preference has a rigid level of flexibility; and
a soft rule to select the execution environment associated with the environment preference when the environment preference has a yielding level of flexibility.

14. The method of claim 11, wherein interrogating the source for the environment preference comprises:
causing a request to present to a user for selection of the environment preference; and
retrieving the environment preference via a user interface available to the user.

15. The method of claim 11, comprising:
exposing a plurality of environment options via an application programming interface.
